(19) United States
(12) Patent Application Publication
(10) Pub. No.: US 2015/0182923 A1
(43) Pub. Date: Jul. 2, 2015

(54) Liquid Agitation System, Kit And Method Of Use

(71) Applicant: ALGENOL BIOFUELS INC., Fort Myers, FL (US)

(72) Inventors: Edwin Malkiel, Naples, FL (US); Oliver Ashley, Fort Myers, FL (US)

(73) Assignee: ALGENOL BIOFUELS INC., Fort Myers, FL (US)

(21) Appl. No.: 14/145,889

(22) Filed: Dec. 31, 2013

(51) Int. Cl. B01F 3/04; B01F 7/00

(52) U.S. Cl. CPC B01F 3/04765; B01F 7/0025; B01F 2215/0052

(57) ABSTRACT

A liquid agitation system comprising an agitation element designed to agitate and mix a liquid medium when in motion on the surface of the liquid medium, thereby enhancing energy efficiency of mass transfer into and out of the liquid medium, a kit for the liquid agitation system and a method of using the agitation element.

### STATEMENT REGARDING FEDERALLY SPONSORED RESEARCH OR DEVELOPMENT

This invention was made in part with United States government support under the Department of Energy grant number DE-EE0002867. The government has certain rights in this invention.

### CROSS-REFERENCE TO RELATED APPLICATIONS

Not applicable.

### REFERENCE TO SEQUENCE LISTING, A TABLE, OR A COMPUTER PROGRAM LISTING COMPACT DISC APPENDIX

Not applicable.

### BACKGROUND

A growing body of evidence has tied global warming to the release of massive quantities of carbon dioxide from burning fossil fuels. Such evidence, combined with the limited supply of fossil fuels and the threat of radioactive contamination from nuclear power plants, has led to a growing interest in renewable energy sources, such as biofuels, in recent years. Conventional biofuels include, for example, ethanol derived from corn and biodiesel converted from soybean oil. As the market for biofuels grows, however, biofuel crop production increasingly competes with food and livestock interests for a limited amount of good agricultural land and clean irrigation water.

Biofuel such as ethanol may alternatively be produced by photosynthetic organisms, such as algae. Algae are the fastest growing plants on earth and one of nature's simplest classes of microorganism; additionally, they are one of the most efficient converters of carbon dioxide and solar energy to biomass. In fact, over 90% of carbon dioxide fed to algae can be absorbed, mostly in the production of algal cell mass. Approximately 477 kJ of free energy are stored in algal biomass for every mole of carbon dioxide consumption during photosynthesis. Algal biomass can be transformed into a high-quality liquid fuel similar to crude oil or diesel fuel through thermochemical conversion, or gasified to produce highly flammable organic fuels suitable for use in gas-burning power plants. Additionally, because algae are capable of growing in a barren environment or saline water, competition for agricultural land may be reduced. These advantages make utilization of algae for fuel production and carbon dioxide mitigation highly desirable.

Conventionally, algae is cultivated in a liquid medium contained in a raceway pond or a photobioreactor. Growth and productivity of the algae depend on diffusion of gaseous carbon dioxide into the liquid medium and diffusion of oxygen out of the liquid medium. Various approaches, such as utilization of a fluid circulator or of fluidically interconnected conduits, have been employed to increase the growth of algae by inducing regular mixing of the liquid medium and improving mass transfer efficiency. These approaches, however, require large capital expenditures and may not result in significant improvements in growth or productivity. Consequently, there is a need for a mixing system that can improve the efficiency of mass transfer between a culture of algae in a liquid medium and gas.

### SUMMARY

An object of the present invention is a liquid agitation system comprising a vessel, a liquid disposed in the vessel at a minimum depth of at least about 1 inch, gas, an agitation element, and a drive system. The agitation element comprises a planar surface and a plurality of surface features that protrude from the planar face. The drive system is configured to move the agitation element within the vessel over a surface of the liquid.

In an embodiment, the vessel is an open pond.

In a further embodiment, the vessel is enclosed.

In a further embodiment, the liquid has a maximum depth of about 2 inches.

In a further embodiment, the surface features comprise ridges having longitudinal axes, and the longitudinal axes of the ridges are parallel to the direction of motion of the agitation element and are spaced apart by a distance of from about 0.5 to about 4.5 times the minimum depth. Elongated depressions are formed between the ridges. The height distance between the ridges and the elongated depressions is about 2 inches. The agitation element has the shape of a rectangular panel about 34 inches long, about 8 inches wide and about 5 inches high and is made of at least one material selected from the group consisting of polystyrene foam and plastic. The drive system comprises magnetically coupled elements, a drive conduit and a pneumatic or hydraulic motive force.

In a further embodiment, a spine is positioned in an elongated depression between two ridges.

In a further embodiment, the surface features comprise hemispherical protrusions, and depressions are formed between the hemispherical protrusions. The height distance between the hemispherical protrusions and the depressions is about 2 inches. The agitation element has the shape of a rectangular panel about 34 inches long, about 8 inches wide and about 5 inches high and is made of at least one material selected from the group consisting of polystyrene foam and plastic. The drive system comprises magnetically coupled elements, a drive conduit and pneumatic or hydraulic motive force.

In a further embodiment, standard aeration efficiency—wire power for the agitation element moving at a speed in a range of from about 0.9 to about 1.2 meters per second is from about 4 pounds per horsepower per hour to about 9 pounds per horsepower per hour.

In a further embodiment, the liquid agitation system comprises a bladder bag and a second liquid having a depth in the bladder bag of from about 7 inches to about 9 inches, wherein the bladder bag is positioned underneath the vessel.

Another object of the present invention is a kit comprising a vessel, liquid having a depth in the vessel of from about 1 inch to about 2 inches, an agitation element, and a drive system. The agitation element comprises a planar surface and a plurality of ridges or a plurality of hemispherical protrusions that protrude from the planar face, with depressions formed between the ridges or hemispherical protrusions.

In an embodiment, the ridges have longitudinal axes, and the longitudinal axes of the ridges are spaced apart by a distance of approximately twice the minimum depth. Elongated depressions are formed between the ridges and the height distance between the ridges and the elongated depressions is about 2 inches.

In a further embodiment, the height distance between the hemispherical protrusions and the depressions is about 2 inches.

In a further embodiment, the kit further comprises a bladder bag and a second liquid having a depth in the bladder bag of from about 7 inches to about 9 inches.

Another object of the present invention is a method of agitating a liquid by moving an agitation element over a surface of a liquid having a depth of from about 1 inch to about 2 inches at a speed in a range of from about 0.9 to about 1.2 meters per second. The agitation element comprises a planar surface and a plurality of ridges having longitudinal axes or a plurality of hemispherical protrusions. The ridges or hemispherical protrusions protrude from the planar surface. Depressions are formed between the ridges or hemispherical protrusions. The longitudinal axes of the ridges are parallel to the direction of motion of the agitation element and are spaced apart by a distance of approximately twice the minimum depth of the liquid. The height distance between the ridges or hemispherical protrusions and the depressions is about 2 inches. The agitation element has the shape of a rectangular panel about 34 inches long, about 8 inches wide and about 5 inches high. Standard aeration efficiency—wire power for the agitation element is from about 4 pounds per horsepower per hour to about 9 pounds per horsepower per hour.

The foregoing and other features and advantages of the invention will become further apparent from the following detailed description of the presently preferred embodiments, read in conjunction with the accompanying drawings. The detailed description and drawings are merely illustrative of the invention, rather than limiting the scope of the invention being defined by the appended claims and equivalents thereof.

### BRIEF DESCRIPTION OF THE SEVERAL VIEWS OF THE DRAWING

Embodiments of the invention will be described below with reference to the following figures.

FIG. 1 shows a bottom perspective view of an embodiment of an agitation element in accordance with the present invention.

FIG. 2 shows a front view of an embodiment of an agitation element in accordance with the present invention.

FIG. 3 shows a bottom perspective view of an embodiment of an agitation element in accordance with the present invention.

FIG. 4 shows a top perspective view of an embodiment of an agitation element in accordance with the present invention

FIG. 5 shows a bottom perspective view of an embodiment of an agitation element in accordance with the present invention.

FIG. 6 shows a bottom perspective view of an embodiment of an agitation element in accordance with the present invention.

FIG. 7 shows a bottom view of an embodiment of an agitation element in accordance with the present invention.

FIG. 8 shows a side view of an embodiment of a liquid agitation system in accordance with the present invention.

FIG. 9 shows a top perspective view of an embodiment of a liquid agitation system in accordance with the present invention.

FIG. 10 shows a sectional view of an embodiment of a liquid agitation system in accordance with the present invention.

FIG. 11 shows a top perspective view of an embodiment of a liquid agitation system in accordance with the present invention.

FIG. 12 shows a plan view of an embodiment of a liquid agitation system in accordance with the present invention.

### DETAILED DESCRIPTION

The present invention provides a liquid agitation system comprising an agitation element designed to agitate and mix the surface of a liquid medium when in motion on the liquid surface, thereby promoting mass transfer and enhancing energy efficiency of mass transfer between the liquid medium and gas above the liquid medium. The invention further provides a kit and a method of using the system.

As used herein, the term “about” means approximately, in the region of, roughly, or around. When the term “about” is used in conjunction with a numerical value/range, it modifies that value/range by extending the boundaries above and below the numerical value(s) set forth. In general, the term “about” is used herein to modify a numerical value(s) above and below the stated value(s) within a confidence interval of 90% or 95%.

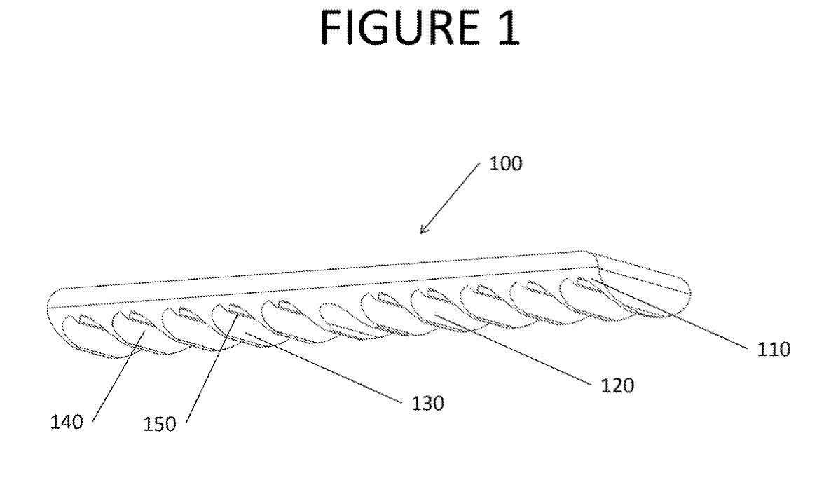

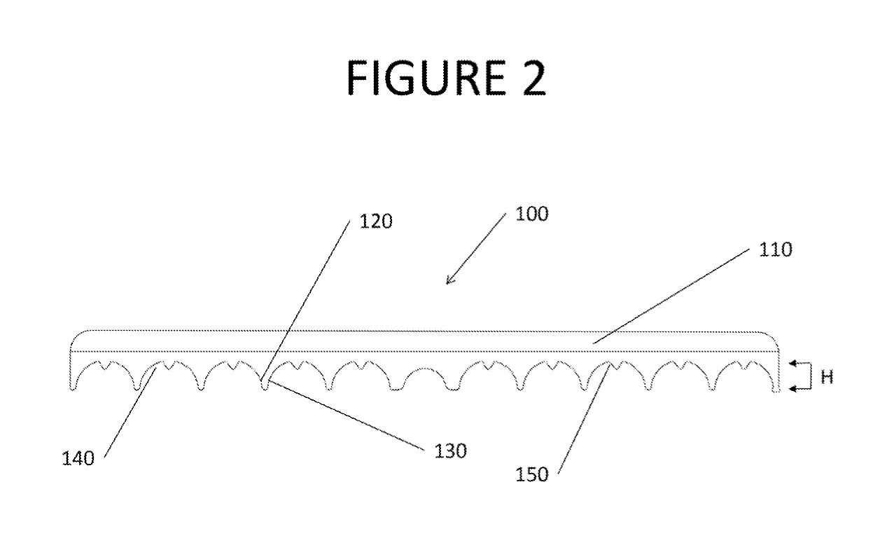

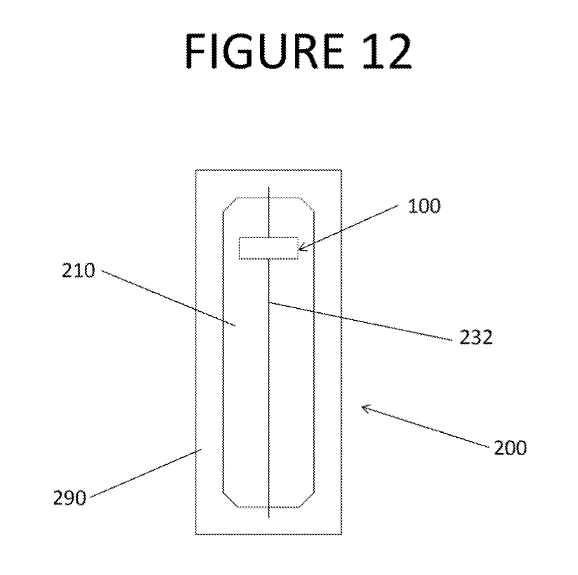

Embodiments of an agitation element 100 of the present invention are shown in FIGS. 1-12. In these embodiments, each agitation element 100 has a form factor of a rectangular panel. A planar face 110 of each embodiment comprises structural features 120 that protrude from the planar face 110 in relief. In some embodiments, the structural features 120 are ridges 130 that form corresponding depressions 140 in the shape of grooves, channels or furrows with semi-circular or semi-oval cross sections. In some embodiments, a raised longitudinal spine 150 is formed in each groove, channel or furrow-shaped depression 140. In some embodiments, the surface features are hemispherical protrusions 160 that form corresponding depressions 140 between the hemispherical protrusions 160. Height distance H between structural feature 120 and depression 140 is illustrated in FIG. 2.

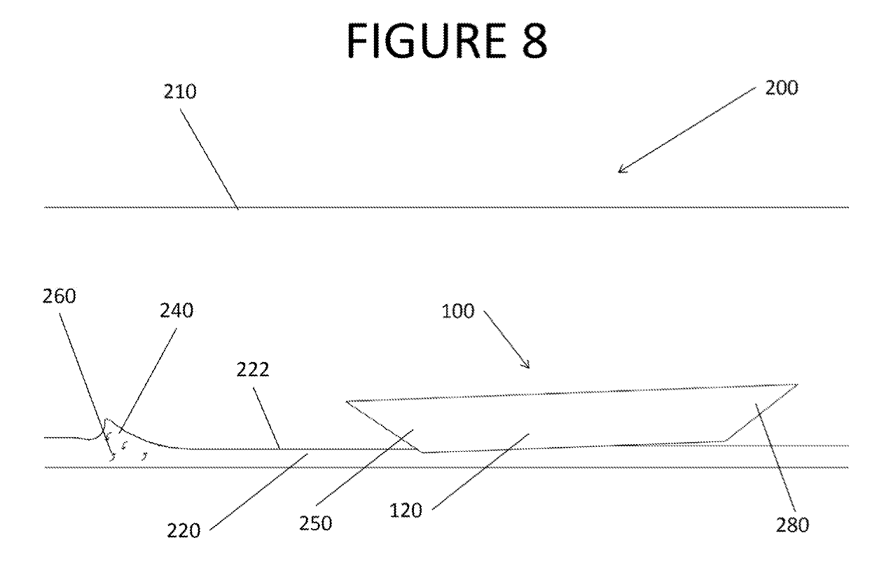

Embodiments of a liquid agitation system 200 of the present invention comprising a vessel 210, an agitation element 100, liquid 220 disposed in the vessel 210 and a drive system 230 are shown in FIGS. 8-12. In some embodiments, the vessel 210 is covered, such as a tank or an enclosed photobioreactor, or is open, such as a raceway pond.

In various embodiments, the planar face 110 of the agitation element 100 that comprises structural features 120 is oriented substantially parallel or at a small angle to a top surface 222 of a liquid medium 220 and is positioned on or slightly below the surface 222 of the liquid medium 220. In accordance with the present invention, the structural features 120 create a non-uniform surface on the planar face 110 of the agitation element 100. When the agitation element 100 is in motion, the structural features 120 present varying resistance to fluid flow past the planar face 110 that contacts the liquid medium 220, thereby creating turbulence at the surface 222 of the liquid medium 220 and inducing vortex formation in the liquid medium 220.

In accordance with the present invention, the agitation element 100 in motion on the surface 222 of a liquid medium 220 creates a wake 240 downstream of a trailing edge 250 of the agitation element 100, as shown in FIG. 8. In some embodiments, the agitation element 100 creates a splashing wake 240, a liquid spray or other splashing of the liquid medium 220 when traversing the surface 222 of the liquid medium 220 at about 1 meter per second. Splashing forms drops and bubbles near the boundary between the liquid medium 220 and gas located above the liquid medium 220 by entraining gas in the liquid 220, effectively increasing the surface area of the liquid medium 220 exposed to the gas above the liquid medium 220 and enhancing energy efficiency of mass transfer of, for example, carbon dioxide and oxygen, between the liquid medium 220 and the gas. A combination of splashing and vortices 260 created by the agitation element 100 may extend the residence time of small bubbles in the liquid medium 220 near the surface 222, which promotes mass transfer. Mass transfer can occur between the liquid medium 220 and atmosphere above the liquid medium 220 in an open vessel 210, or between gas in a headspace above a liquid medium 220 in an enclosed vessel 210.

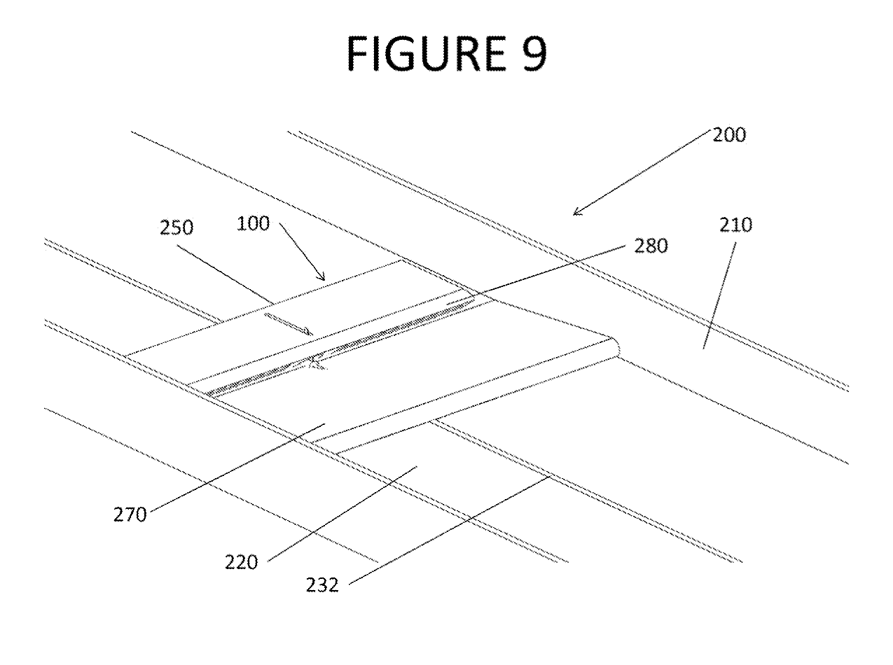

In some embodiments, as shown in FIG. 9, the agitation element 100 creates a hydraulic jump 270 in the liquid medium 220. A bow wave 270 is created at a leading edge 280 of the agitation element 100. The depth of undisturbed liquid 220 located immediately in front of the bow wave 270 is shallower than the liquid 220 depth of the bow wave 270. The bow wave 270 travels at the speed of the agitation element 100, which is faster than the liquid 220 wave speed immediately in front of the bow wave 270.

The bow wave 270 is a travelling hydraulic jump 270 or bore. In accordance with the present invention, the hydraulic jump 270 further increases the surface area of the liquid medium 220 exposed to gas and induces turbulent mixing, concomitantly promoting mass transfer between the liquid medium 220 and the gas. In some embodiments of the present invention, the hydraulic jump 270 is moving and the water 220 is generally stationary, only experiencing temporary unsteady flow when the agitation element 100 passes over the surface 222.

Bow waves 270 are characterized by the Froude number, U/(gh)^{0.5}, where h is the upstream depth, g is gravity and U is the speed of the agitation element 100 or wave 270. In some embodiments of the present invention, the Froude number of the bow wave 270 is less than 2, and the bow wave 270 is classified as a weak travelling hydraulic jump 270 that is not strongly dissipative. See White, F.M. Fluid Mechanics 2^{nd} ed., New York, 1982 p. 610.

Weak hydraulic jumps 270 are also commonly induced in dam spillways to dissipate energy and in wastewater treatment to promote mixing. In such applications, water 220 is moving steadily and the weak hydraulic jump 270 remains stationary at the location where the water 220 moves from a supercritical region to a subcritical region.

Additionally, a hydraulic jump 270 can disturb and mix portions of the liquid medium 220 that are not within the immediate area of the agitation element's 100 traverse, which promotes mass transfer over the surface 222 of the liquid medium 220. In some embodiments, the liquid medium 220 mixed by the agitation element 100 is disposed in a vessel 210, with gaps present between the sides of the vessel 210 and the edges of the agitation element 100. A hydraulic jump 270 spreads beyond the immediate path of the agitation element 100 and mixes the surface 222 of the liquid medium 220 that does not directly contact the agitation element 100. This effect significantly improves mass transfer at the liquid medium 220 surface.

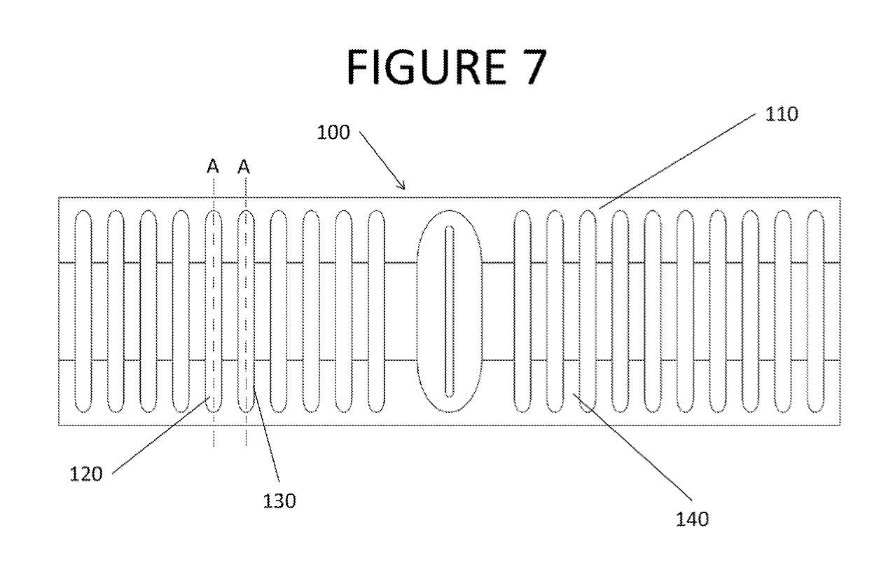

In some embodiments, as shown in FIG. 7, the longitudinal axes A of the ridges 130 are parallel to the direction of linear movement of the agitation element 100 and are spaced widely enough, for example approximately twice the minimum depth of the liquid medium 220, to produce stationary recirculation patterns in a liquid medium 220 when the agitation element 100 is moving at about 1 meter per second.

In embodiments that create a wake 240 in the liquid 220 and in which the longitudinal axes A of the ridges 130 are parallel to the direction of linear movement of the agitation element 100 on the surface 222 of a liquid medium 220, form drag is minimized so that hydraulic drag is equivalent to skin friction, thereby economizing energy required to keep the agitation element 100 in motion. The ridges 130 may act as steering elements that keep the agitation element 100 aligned with its direction of movement.

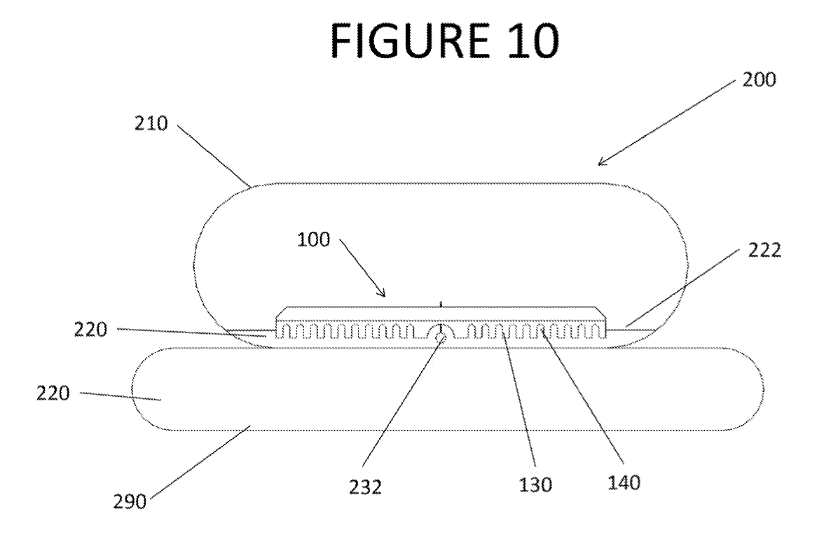

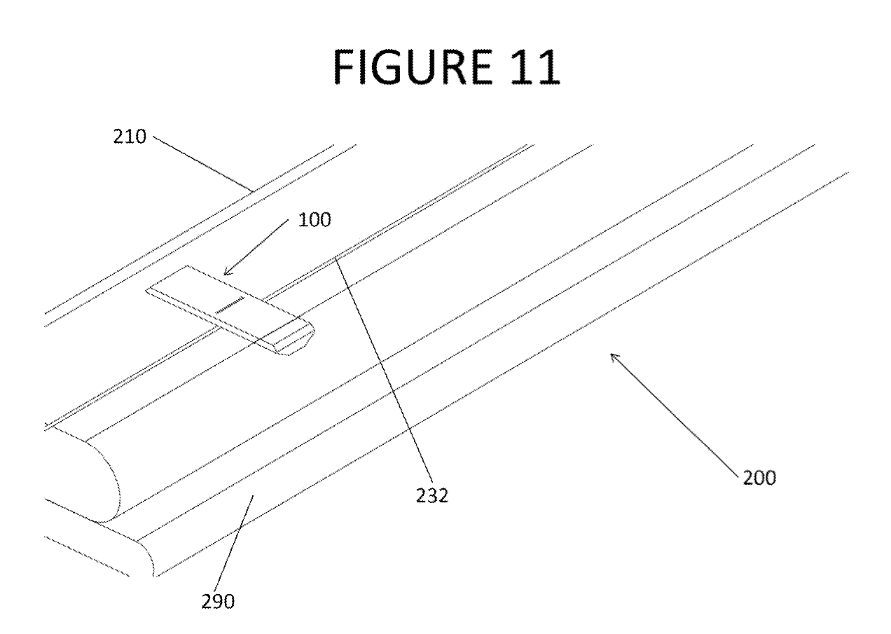

In accordance with the present invention, motion of the agitation element 100 is not extensively affected by shape or geometry of a bottom surface of the vessel 210 in which the agitation element 100 is disposed, so that the bottom surface of the vessel 210 may be made of either rigid material that retains its shape or flexible material that deforms if placed on an irregular surface. In some embodiments, as shown in FIGS. 10 and 11, the vessel 210 is positioned on top of a liquid-filled structure such as a bladder bag 290. In some embodiments, the bladder bag 290 is filled with about 7-9 inches of liquid 220 such as water. The liquid 220 contained in the bladder bag 290 acts as a heat sink that mitigates temperature variation in the liquid medium 220 contained in the vessel 210. Additionally, if the vessel 210 and the bladder bag 290 are made of flexible film, the contacting surfaces of the vessel 210 and the bladder bag 290 lie flatter and more uniformly.

In some embodiments, the liquid medium 220 contains a culture of microorganisms (not shown), such as photoautotrophs, and the culture of photoautotrophs is exposed to sunlight in an open vessel 210 or in an enclosed vessel 210 that is at least partially translucent. The agitation element 100 traverses the liquid surface 222 and mixes the culture of photoautotrophs. Concentration gradients cause carbon dioxide to diffuse from the atmosphere or headspace into the liquid medium 220, where carbon dioxide is consumed by the photoautotrophic organisms, and oxygen formed by the photoautotrophic organisms to diffuse into the atmosphere or headspace. Splashing, vortices 260 and hydraulic jumps 270 created by an agitation element 100 of the present invention increase the surface area of the liquid medium 220 exposed to gas and thereby increase the energy efficiency of mass transfer between the liquid medium 220 and the gas. Increasing the supply of carbon dioxide to a culture of photoautotrophs in the liquid medium 220 and increasing the removal of oxygen evolved by the photoautotrophs helps to increase growth and productivity of the culture. Additionally, when foam is made by the culture of photoautotrophs, movement of the agitation element 100 across the surface 222 of the liquid medium 220 can advantageously push the foam to the edges of the vessel 210, thus maintaining exposure of the culture to sunlight.

In some embodiments, a drive system 230 moves an agitation element 100 across the surface 222 of a liquid medium 220 that is contained in a vessel 210 such as an enclosed photobioreactor or a raceway pond. The drive system 230 moves the agitation element 100 from one side of the vessel 210 and reverses the direction of motion when the agitation element 100 reaches another side of the vessel 210, to create a reciprocating pattern of motion across the vessel 210. In some embodiments, the drive system 230 comprises magnetically coupled elements (not shown), a drive conduit 232 on which the agitation element rides and a pneumatic or hydraulic motive force (not shown). The magnetically coupled elements may comprise a magnetic or ferromagnetic element incorporated in or on the agitation element and a corresponding ferromagnetic or magnetic element propelled by the motive force in the drive conduit 232, causing the agitation element 100 to move. Exemplary magnetically coupled pneumatic and hydraulic drive systems 230 suitable for use with the present invention are disclosed in U.S. Ser. No. 13/405,012, filed on Feb. 24, 2012, issued as U.S. Pat. No. 8,398,296, the entire disclosure of which is hereby incorporated by reference.

One of ordinary skill in the art will appreciate that the form factor and dimensions of an agitation element 100 of the present invention can be selected to conform to the vessel 210 containing the liquid medium 220, such that the agitation element 100 provides suitable coverage agitation of the liquid medium surface 222. An agitation element 100 of the present invention may have a combination of dimensions that provide a desired balance of, for example, cost, rigidity over the surface area of the agitation element 100, weight and durability, An agitation element 100 designed for use with a liquid culture of photoautotrophic microorganisms will be dimensioned to balance mixing effects with exposure of the photosynthetic microorganisms to sunlight.

Examples of suitable materials for construction of an agitation element 100 of the present invention are extruded polystyrene foam, plastic, wood or any other material with desirable properties such as light weight, low cost, high strength and rigidity, and high resistance to corrosion and ultraviolet light, for example. In some embodiments, the material for construction is buoyant in liquid 220.

### Example 1

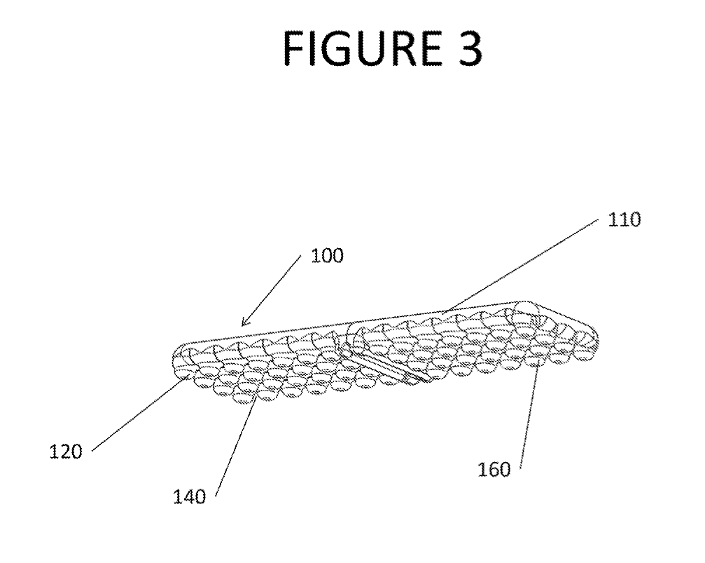

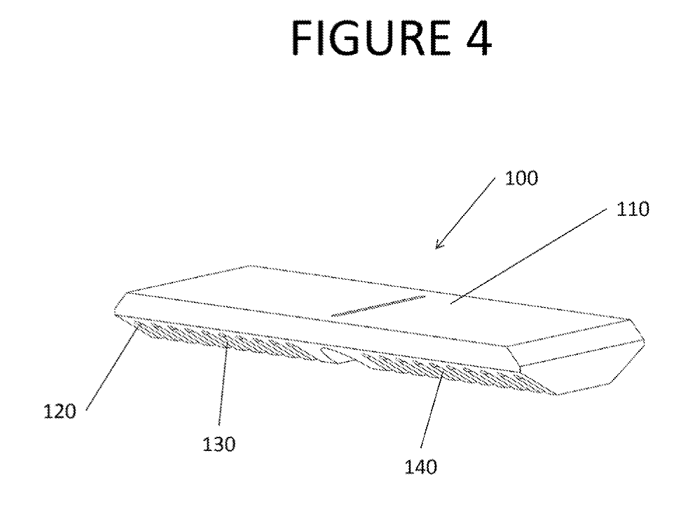

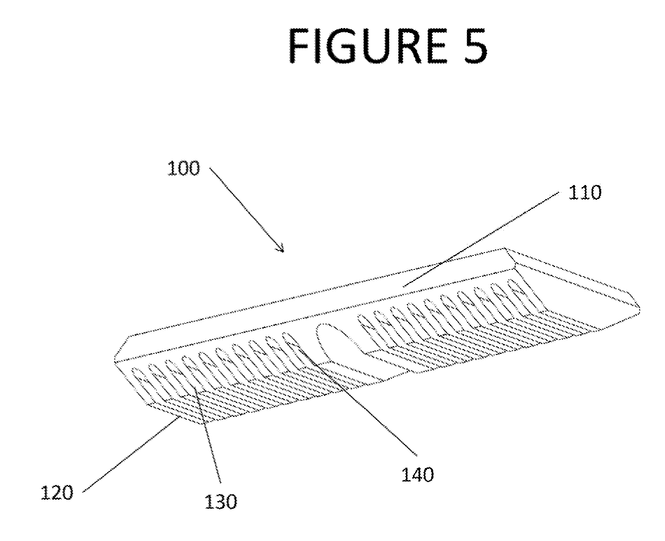

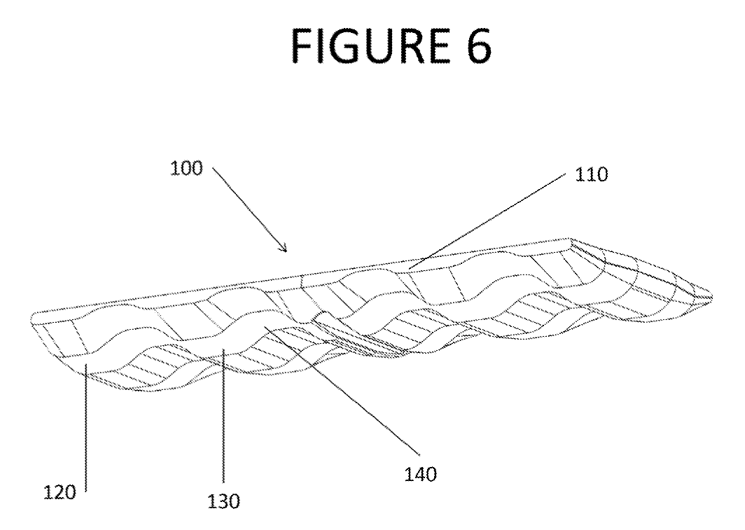

In a working example, embodiments of an agitation element of the present invention shown in FIGS. 1-7 were configured to traverse lengthwise an open raceway measuring about 50 feet long by about 5 feet wide and filled with about 1-2 inches of tap water supersaturated with dissolved oxygen. The agitation elements each measured about 34 inches long by about 8 inches wide by about 5 inches high. The height of the ridges shown in FIGS. 1 and 2 was about two inches compared to the depressions between the ridges, and the spacing between ridges was about four inches. The height of the hemispherical protrusions shown in FIG. 3 was about two inches compared to the depressions between the hemispherical protrusions, and the spacing between hemispherical protrusions was about four inches. The height of the ridges shown in FIGS. 4 and 5 was about two inches compared to the depressions between the ridges, the spacing between ridges was about one inch, and the width of each ridge was about one inch. The height of the ridges shown in FIG. 6 was about two inches compared to the depressions between the ridges, and the spacing between ridges was about eight inches.

A pneumatic drive system with regulated, pressurized air propelled each agitation element along the length of the raceway at the mean speeds identified in Table 1. Upon the agitation element reaching an end of the raceway, a 4-way valve reversed the direction of the pneumatic pressure and propelled the agitation element to the opposite end of the raceway, completing one cycle of motion. Pneumatic pressure and flow rate were monitored with digital instruments and reported as mean values for movement of the agitation element at a steady rate.

Mass transfer was measured by recording the decreased dissolved oxygen concentration of the water in the raceway as a function of time until it had at least decayed to one-half its initial value. The oxygen concentration in the liquid, C_{L}, decreases exponentially, satisfying the rate Equation (1), where K_{L}a is the mass transfer coefficient, and Cₒₒ^{*} is the oxygen concentration in the liquid when in equilibrium with oxygen concentration in the atmosphere. Mass transfer from non-mixed water in the raceway to the surrounding atmosphere was found to be negligible compared to mass transfer values for the mixing tests, and therefore baseline mass transfer for non-mixed water was excluded from the analysis.

$$\frac{d {C}_{L}}{d t} = {K}_{L} a ( {C}_{∞}^{*} - {C}_{L} ) \qquad Equation ( 1 )$$

Values for Kₗa were determined from the decay rate of dissolved oxygen concentration, by fitting the concentration on a semi-log plot, where K_{L} a is found from Equation (2), in which the subscript 0 represents initial conditions.

$${K}_{L} a = \frac{ln \vert {C}_{∞}^{*} - {C}_{L 0} \vert - ln \vert {C}_{∞}^{*} - {C}_{L } \vert}{t - {t}_{0}} \qquad Equation ( 2 )$$

A comprehensive review of conventional methods for agitating and aerating liquid in tanks and lagoons through surface disturbance and mechanical means is given in Chapter 5 (pgs. 203-244) of Mueller et al., Aeration: Principles and Practice, CRC Press, 2002. This reference covers many types of surface and mechanical agitation and aeration that have been used in water treatment. The most efficient designs reviewed incorporate horizontal and vertical rotors that increase oxygen gas transfer through agitating the liquid surface. Such rotors act as direct surface piercing elements that induce the entrainment of air into the liquid, or produce jets or sprays of liquid, to increase interfacial area.

For the purpose of comparing efficiencies of such systems, which are listed in the Tables 5.3 and 5.4 of Mueller et al., standard oxygen transfer rates (SOTR) were calculated according to Equation (3), using the experimentally determined KLa values measured at the standard conditions of atmospheric pressure and 20° C., with C_{L} set at 0 using clean water.

$$S O T R = V ( \frac{d {C}_{L}}{d t} ) = {K}_{L} a ( {C}_{∞}^{*} - {C}_{L } ) V \qquad Equation ( 3 )$$

SOTR is further normalized by the electrical energy required to power the agitation element to yield Standard Aeration Efficiency—Wire Power, or SAE WP, as calculated in Equation (4), For the results presented in Table 1 below, SAE WP was calculated with a 50% overall compressor efficiency (assuming 60% adiabatic compressor efficiency and 85% motor efficiencies).

$$S A E = \frac{S O T R}{WP} \qquad Equation ( 4 )$$

TABLE 1

| | | Cycle | Water | | Mass | | Total | SOTR | SAE |
|---|---|---|---|---|---|---|---|---|---|
| | Speed | Time | Depth | Pressure | Flow | K_{L}a | Energy | (Kg- | WP |
| Embodiment | (m/s) | (s) | (in) | (psig) | (SLPM) | (hr⁻¹)* | (watts) | O₂/hr) | (lb/hp-h) |
| FIGS. 1 | 0.94 | 32 | 1.5 | 2.0 | 8.8 | 1.5 | 3.8 | 0.015 | 8.9 |
| and 2 | | | | | | | | | |
| FIG. 3 | 0.92 | 37 | 1.0 | 3.8 | 11.0 | 1.6 | 7.9 | 0.016 | 4.6 |
| FIGS. 4 | 0.95 | 46 | 1.8 | 6.9 | 9.5 | 1.7 | 9.1 | 0.018 | 4.4 |
| and 5 | | | | | | | | | |
| FIGS. 4 | 0.94 | 32 | 1.5 | 4.3 | 10.0 | 1.5 | 8.9 | 0.016 | 4.1 |
| and 5 | | | | | | | | | |
| FIG. 3 | 1.06 | 32 | 2.0 | 6.0 | 13.0 | 2.4 | 14.2 | 0.026 | 4.0 |
| FIG. 6 | 1.17 | 29 | 1.8 | 3.0 | 12.8 | 1.3 | 7.3 | 0.013 | 4.0 |
| Conventional | | | | | | | | | 3.4 ± 0.3 |
| surface | | | | | | | | | |
| aerators¹ | | | | | | | | | |

¹Mueller et al., Aeration: Principles and Practice, CRC Press, 2002.
*Adjusted for a 2 inch water depth for purposes of comparing K_{L}a, across different depths using Equation (5), which assumes that the piston velocity K_{L}, or the mass transfer of K_{L}a, is constant, while the “a” that represents the interfacial area/volume is only influenced by depth h in that the volume changes as h * A, where A is the plan area of the basin. In Equation (5), depth must be input as inches. Although this adjustment is illustrative in comparing mass transfer, SOTR can be calculated with or without the adjustment and will produce the same values as listed in Table 1, as long as the corresponding volume V (adjusted or nonadjusted) is used.

$${( {K}_{L} a )}_{2} = ( \frac{h}{2} ) {( {K}_{L} a )}_{meas} \qquad Equation ( 5 )$$

The agitation element designs of the present invention outperformed conventional surface aerators as measured by SAE WP values. Energy efficiency of the embodiment shown in FIGS. 1 and 2 was more than 2.6 times greater than energy efficiency of the conventional surface aerators. This is most likely due to the fact that the mixing systems of the present invention in Example 1 were deployed in basins with relatively shallow depths, where the combination of a recirculating transverse vortex motion with weak hydraulic jumps dissipates little energy but greatly contributes to enhanced gas transfer.

Although the present disclosure has been described in considerable detail with reference to certain embodiments thereof, other embodiments are possible. Therefore, the spirit and scope of the appended claims should not be limited to the description of the embodiments contained herein, and all changes that come within the meaning and range of equivalents are intended to be embraced therein.

What is claimed is:

1. A liquid agitation system comprising:
a. a vessel;
b. a liquid disposed in the vessel, the liquid having a surface and a minimum depth of at least about 1 inch;
c. gas above the liquid surface;
d. an agitation element disposed on the liquid surface, the agitation element comprising a planar surface and a plurality of surface features that protrude from the planar face; and
e. a drive system configured to move the agitation element within the vessel over the liquid surface;
whereby the agitation element agitates the liquid.

2. The system of claim 1 wherein the vessel is an open pond.

3. The system of claim 1 wherein the vessel is enclosed.

4. The system of claim 1 wherein the liquid has a maximum depth of about 2 inches.

5. The system of claim 1 wherein the surface features comprise ridges having longitudinal axes, further wherein the longitudinal axes of the ridges are parallel to the direction of motion of the agitation element and are spaced apart by a distance of from about 0.5 to about 4.5 times the minimum depth, further wherein elongated depressions are formed between the ridges, further wherein the height distance between the ridges and the elongated depressions is about 2 inches, further wherein the agitation element has the shape of a rectangular panel about 34 inches long, about 8 inches wide and about 5 inches high and is made of at least one material selected from the group consisting of polystyrene foam and plastic, and further wherein the drive system comprises magnetically coupled elements, a drive conduit and a pneumatic or hydraulic motive force.

6. The system of 5 further comprising a spine positioned in an elongated depression between two ridges.

7. The system of claim 5 wherein standard aeration efficiency—wire power for the agitation element moving at a speed in a range of from about 0.9 to about 1.2 meters per second is from about 4 pounds per horsepower per hour to about 9 pounds per horsepower per hour.

8. The system of claim 1 wherein the surface features comprise hemispherical protrusions, further wherein depressions are formed between the hemispherical protrusions, further wherein the height distance between the hemispherical protrusions and the depressions is about 2 inches, further wherein the agitation element has the shape of a rectangular panel about 34 inches long, about 8 inches wide and about 5 inches high and is made of at least one material selected from the group consisting of polystyrene foam and plastic, and further wherein the drive system comprises magnetically coupled elements, a drive conduit and pneumatic or hydraulic motive force.

9. The system of claim 8 wherein standard aeration efficiency—wire power for the agitation element moving at a speed in a range of from about 0.9 to about 1.2 meters per second is from about 4 pounds per horsepower per hour to about 9 pounds per horsepower per hour.

10. The system of claim 1 further comprising a bladder bag and a second liquid having a depth in the bladder bag of from about 7 inches to about 9 inches, wherein the bladder bag is positioned underneath the vessel.

11. A kit comprising
a. a vessel;
b. a liquid having a depth in the vessel of from about 1 inch to about 2 inches;
c. an agitation element, the agitation element comprising a planar surface and a plurality of ridges or a plurality of hemispherical protrusions that protrude from the planar face, wherein depressions are formed between the ridges or hemispherical protrusions; and
d. a drive system.

12. The kit of claim 11 wherein the ridges have longitudinal axes, further wherein the longitudinal axes of the ridges are spaced apart by a distance of approximately twice the minimum depth, further wherein elongated depressions are formed between the ridges and further wherein the height distance between the ridges and the elongated depressions is about 2 inches.

13. The kit of claim 11 wherein the height distance between the hemispherical protrusions and the depressions is about 2 inches.

14. The kit of claim 11 further comprising a bladder bag and a second liquid having a depth in the bladder bag of from about 7 inches to about 9 inches.

15. A method of agitating a liquid, the method comprising moving an agitation element over a surface of a liquid having a depth of from about 1 inch to about 2 inches at a speed in a range of from about 0.9 to about 1.2 meters per second, wherein the agitation element comprises a planar surface and a plurality of ridges having longitudinal axes or a plurality of hemispherical protrusions, further wherein the ridges or hemispherical protrusions protrude from the planar surface, further wherein depressions are formed between the ridges or hemispherical protrusions, further wherein the longitudinal axes of the ridges are parallel to the direction of motion of the agitation element and are spaced apart by a distance of approximately twice the minimum depth of the liquid, further wherein the height distance between the ridges or hemispherical protrusions and the depressions is about 2 inches, further wherein the agitation element has the shape of a rectangular panel about 34 inches long, about 8 inches wide and about 5 inches high, and further wherein standard aeration efficiency—wire power for the agitation element is from about 4 pounds per horsepower per hour to about 9 pounds per horsepower per hour.
